(19) United States
(12) Patent Application Publication
(10) Pub. No.: US 2017/0320648 A1
(43) Pub. Date: Nov. 9, 2017

(54) Carton For Articles

(71) Applicant: Graphic Packaging International, Inc., Atlanta, GA (US)

(72) Inventors: Ross Droege, Atlanta, GA (US); Elias Spartis, Roswell, GA (US); Raymond R. Spivey, SR., Mableton, GA (US); Mark Baldino, Marietta, GA (US)

(21) Appl. No.: 15/586,482

(22) Filed: May 4, 2017

Related U.S. Application Data
(60) Provisional application No. 62/332,726, filed on May 6, 2016.

(51) Int. Cl. B65D 71/36; B65D 5/72; B65D 5/42; B65D 5/46; B65D 5/62; B65D 5/10

(52) U.S. Cl. CPC B65D 71/36; B65D 5/62; B65D 5/10; B65D 5/4266; B65D 5/46192; B65D 5/725; B31B 2241/001; B65D 2571/00141; B65D 2571/00469; B65D 2571/00728

(57) ABSTRACT

A carton for containing a plurality of containers includes a plurality of panels and a plurality of end flaps. The plurality of end flaps is foldably connected to respective panels of the plurality of panels and at least partially closes an end of the carton. The plurality of end flaps includes a first end flap foldably connected to one of a top panel and a bottom panel at a first fold line, a second end flap foldably connected to the one of the top panel and the bottom panel at a second fold line that is oblique to the first fold line, and a third end flap foldably connected to the at least one side panel at a third fold line. The third end flap has at least one notch overlapping at least a portion of one of the first end flap and the second end flap.

### CROSS-REFERENCE TO RELATED APPLICATION

This application claims the benefit of U.S. Provisional Patent Application No. 62/332,726, which was filed on May 6, 2016.

### INCORPORATION BY REFERENCE

The disclosures of U.S. Provisional Patent Application No. 62/332,726, which was filed on May 6, 2016, U.S. patent application Ser. No. 14/286,343, which was filed on May 23, 2014, U.S. Provisional Patent Application No. 61/855,819, which was filed on May 24, 2013, and U.S. Provisional Patent Application No. 61/956,388, which was filed on Jun. 7, 2013, are hereby incorporated by reference for all purposes as if presented herein in their entirety.

### BACKGROUND OF THE DISCLOSURE

The present disclosure generally relates to cartons for holding beverage containers or other types of articles. More specifically, the present disclosure relates to cartons configured to receive articles in a nested arrangement.

### SUMMARY OF THE DISCLOSURE

According to one aspect of the disclosure, a carton for containing a plurality of containers comprises a plurality of panels and a plurality of end flaps. The plurality of panels extends at least partially around an interior of the carton and comprises a bottom panel, a top panel, and at least one side panel. The plurality of end flaps is foldably connected to respective panels of the plurality of panels and at least partially closes an end of the carton. The plurality of end flaps comprises a first end flap foldably connected to one of the top panel and the bottom panel at a first fold line, a second end flap foldably connected to the one of the top panel and the bottom panel at a second fold line that is oblique to the first fold line, and a third end flap foldably connected to the at least one side panel at a third fold line. The third end flap has at least one notch overlapping at least a portion of one of the first end flap and the second end flap.

According to another aspect of the disclosure, a blank for forming a carton for containing a plurality of containers comprises a plurality of panels and a plurality of end flaps. The plurality of panels is for folding at least partially around an interior of the carton and comprises a bottom panel, a top panel, and at least one side panel. The plurality of end flaps is foldably connected to respective panels of the plurality of panels and is for at least partially closing an end of the carton when the carton is formed from the blank. The plurality of end flaps comprises a first end flap foldably connected to one of the top panel and the bottom panel at a first fold line, a second end flap foldably connected to the one of the top panel and the bottom panel at a second fold line that is oblique to the first fold line, and a third end flap foldably connected to the at least one side panel at a third fold line and having at least one notch for overlapping at least a portion of one of the first end flap and the second end flap when the carton is formed from the blank.

According to another aspect of the disclosure, a method of forming a carton for containing a plurality of containers comprises obtaining a blank comprising a plurality of panels and a plurality of end flaps, and folding the plurality of panels and the plurality of end flaps. The plurality of panels comprises a bottom panel, a top panel, and at least one side panel, and the plurality of end flaps are foldably connected to respective panels of the plurality of panels and comprise a first end flap foldably connected to one of the top panel and the bottom panel at a first fold line, a second end flap foldably connected to the one of the top panel and the bottom panel at a second fold line that is oblique to the first fold line, and a third end flap foldably connected to the at least one side panel at a third fold line and having at least one notch. The plurality of end flaps are folded to extend at least partially around an interior of the carton such that the at least one notch overlaps at least a portion of one of the first end flap and the second end flap.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of a blank for forming a carton according to one exemplary embodiment of the disclosure.

FIG. 2 is a schematic view of various configurations of containers for disposition in a carton according to exemplary embodiments of the disclosure.

FIG. 3 is an open-ended configuration of a carton formed from the blank of FIG. 1 according to one exemplary embodiment of the disclosure

FIG. 4 is a first sequential perspective view of a folding operation of an end of the carton of FIG. 3.

FIG. 5 is a second sequential perspective view of a folding operation of an end of the carton of FIG. 3.

FIG. 6 is a third sequential perspective view of a folding operation of an end of the carton of FIG. 3.

FIG. 7 is a fourth sequential perspective view of a folding operation of an end of the carton of FIG. 3.

FIG. 8 is a fifth sequential perspective view of a folding operation of an end of the carton of FIG. 3.

FIG. 9 is a sixth sequential perspective view of a folding operation of an end of the carton of FIG. 3.

FIG. 10 is a first sequential perspective view of a folding operation of an end of the carton of FIG. 3.

FIG. 11 is a first sequential perspective view of a folding operation of an end of the carton of FIG. 3.

FIG. 12 is a second sequential perspective view of a folding operation of an end of the carton of FIG. 3.

FIG. 13 is a third sequential perspective view of a folding operation of an end of the carton of FIG. 3.

FIG. 14 is a perspective view of the carton of FIG. 3 in a closed configuration.

FIG. 15 is a first sequential perspective view of the carton of FIG. 14 in a dispensing operation.

FIG. 16 is a second sequential perspective view of the carton of FIG. 14 in a dispensing operation.

Corresponding parts are designated by corresponding reference numbers throughout the drawings.

### DETAILED DESCRIPTION OF THE EXEMPLARY EMBODIMENT

The present disclosure generally relates to cartons that contain articles, for example, containers such as bottles, cans, etc. The articles can be used, for example, for packaging food and beverage products. The articles can be made from materials suitable in composition for packaging the particular food or beverage item, and the materials include, but are not limited to, aluminum and/or other metals; glass; plastics such as PET, LDPE, LLDPE, HDPE, PP, PS, PVC, EVOH, and Nylon; and the like, or any combination thereof

Cartons according to the present disclosure can accommodate articles of any shape. For the purpose of illustration and not for the purpose of limiting the scope of the disclosure, the following detailed description describes beverage containers (e.g., aluminum cans or glass beverage bottles) as disposed within the carton embodiments. In this specification, the terms “inner,” “outer,” “lower,” “bottom,” “upper,” and “top” indicate orientations determined in relation to fully erected and upright cartons.

As described herein, cartons may be formed by multiple overlapping panels and/or end flaps. Such panels and/or end flaps may be designated in relative terms to one another, e.g., “first”, “second”, “third”, etc., in sequential or non-sequential reference without departing from the disclosure.

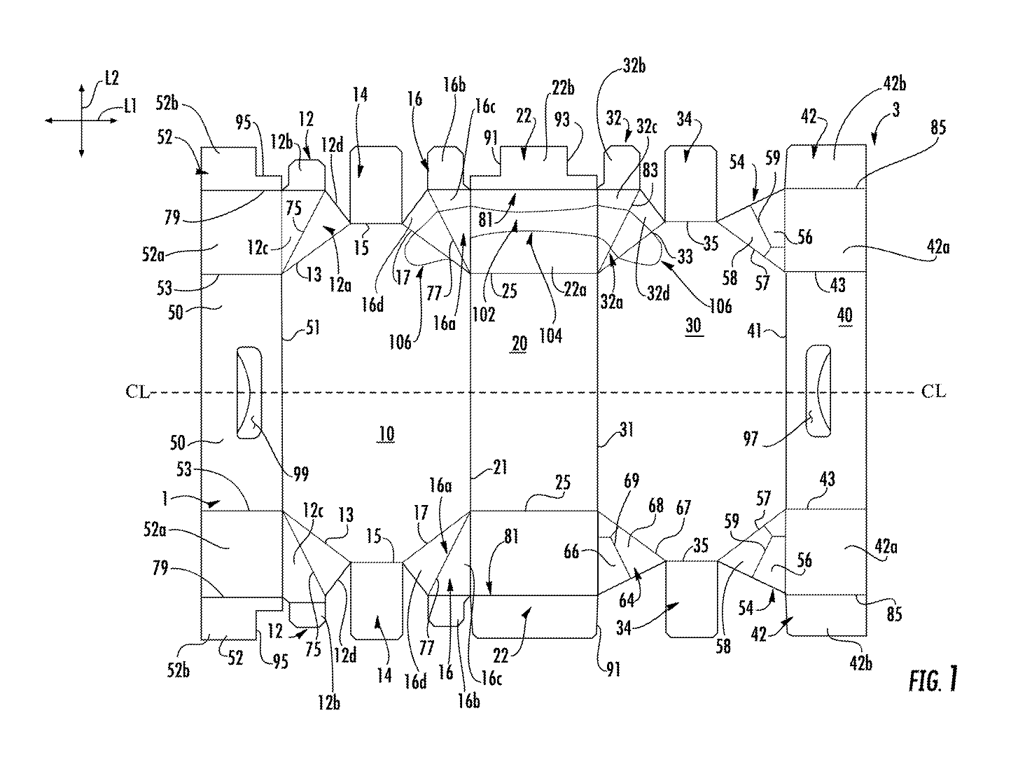

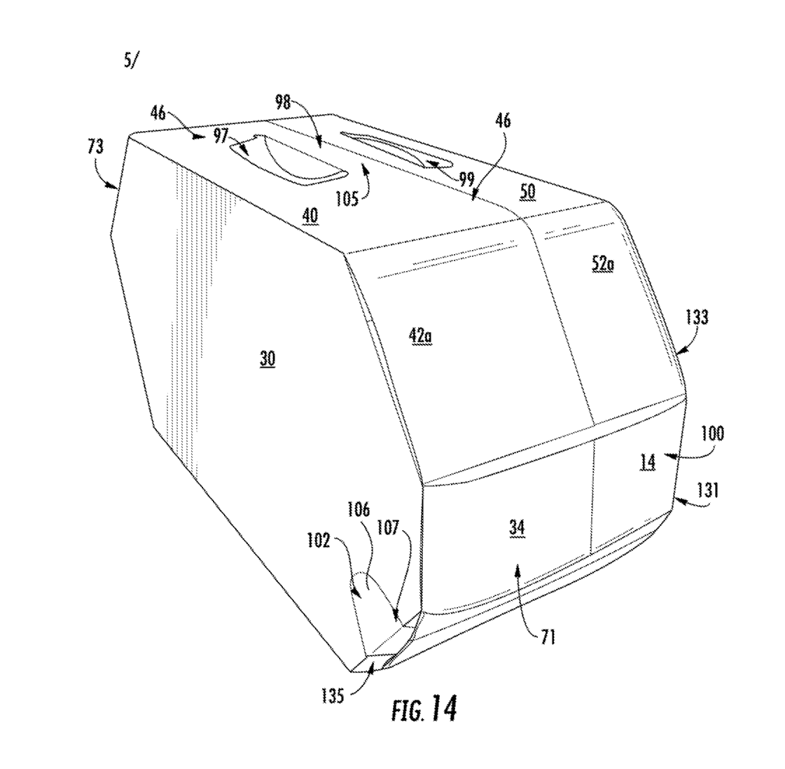

FIG. 1 is a plan view of the interior side 1 of a blank, generally indicated at 3, used to form a carton 5 (FIG. 14) according to one exemplary embodiment of the disclosure. The carton 5 can be used to house a plurality of articles such as containers in the form of beverage cans C (FIG. 42). The carton 5 includes features for facilitating conservation of board material when housing the cans C in a nested arrangement. Additionally, the carton 5 can have a different visual configuration than conventional cartons, for example, so that carton 5 can be more noticeable and/or more easily distinguishable from other cartons on display. As described herein, the carton 5 has features to increase the strength of the carton 5 and opening features to facilitate access to the cans C.

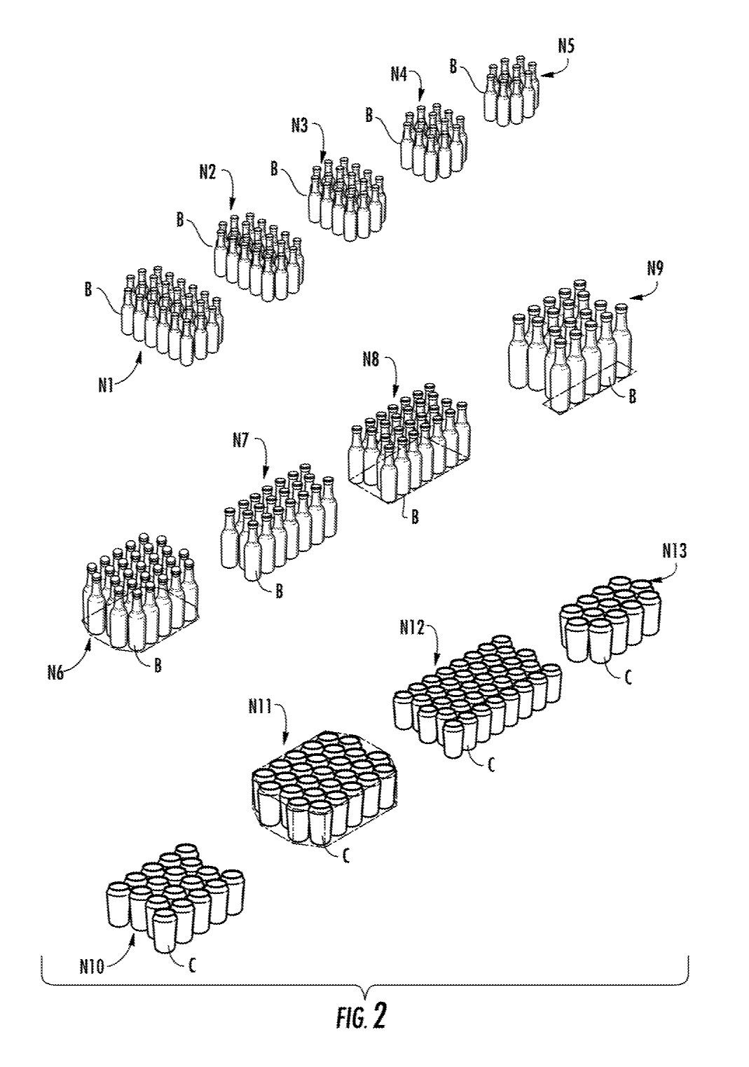

Referring additionally to FIG. 2, in the first embodiment, the carton 5 is sized and configured to contain thirteen cans C in a single layer in a “nested” arrangement N13 having two outer rows of four cans C per row and one inner row of five cans C per row. FIG. 2 also shows various nested pack arrangements for use with carton 5 or other cartons of the disclosure, which include various arrangements for cans C and other containers, such as bottles B. The arrangements N1-N5 and N13 and/or other arrangements shown and not shown in the illustrated embodiments can be considered “fully nested” arrangements. In one embodiment, a fully nested arrangement of containers can have at least one outer row and at least one inner row, wherein each of the inner row(s) can have at least one more container than an outer row. For example, nested arrangement N1 can have six bottles B in each of two outer rows and seven bottles B in each of two inner rows, wherein each of the outer rows is nested with a respectively adjacent inner row. In one embodiment, at least the nesting arrangements N6-N12 can be considered “inverted” or “internal” nesting arrangements since one or more of the interior rows of bottles B or cans C are generally shorter than the outer rows of containers B or C. Other nested or non-nested arrangements of the containers including bottles B or cans C could be provided without departing from the disclosure.

Still referring to FIG. 1, the blank 3 has a longitudinal axis L1 and a lateral axis L2. In the illustrated embodiment, the blank 3 comprises a bottom panel 10 foldably connected to a first side panel 20 at a first lateral fold line 21, a top panel 30 foldably connected to the first side panel 20 at a second lateral fold line 31, a second side panel 40 foldably connected to the top panel 30 at a third lateral fold line 41, and a third side panel 50 foldably connected to the bottom panel 10 at a fourth lateral fold line 51. In the carton 5 (FIG. 14) formed from the blank 3, the second side panel 40 and the third side panel 50 overlap to form a side panel 46 (FIG. 2) of the carton 5.

As shown, the bottom panel 10 is foldably connected to a first group of bottom end flaps comprising three bottom end flaps 12, 14, 16 respectively foldably connected to the bottom panel 10 at respective fold lines 13, 15, 17. The first side panel 20 is foldably connected to a first side end flap 22 at a longitudinal fold line 25. As shown, the first side end flap 22 has notches 91, 93 formed along lateral end portions thereof The top panel 30 is foldably connected to a first top end flap 32 at an oblique fold line 33 and a second top end flap 34 at a longitudinal fold line 35. Similarly, the second side panel 40 is foldably connected to a second side end flap 42 at a longitudinal fold line 43. The third side panel 50 is foldably connected to a third side end flap 52 at a longitudinal fold line 53. One or more of the bottom end flaps 12, 14, 16, the side end flaps 22, 42, 52, and the top end flaps 32, 34 could be omitted or could be otherwise shaped, arranged, configured, and/or positioned without departing from the disclosure.

In one embodiment, as shown, the second side end flap 42 is foldably connected to the top panel 30 at a gusset 54 that includes a first gusset panel 56 and a second gusset panel 58. The second gusset panel 58 is foldably connected to the top panel 30 at an oblique fold line 57, is foldably connected to the first gusset panel 56 at an oblique fold line 59, and is foldably connected to the end flap 42 along a portion of the fold line 41. In embodiments, the gusset 54 could be omitted or could be otherwise shaped, arranged, configured, and/or positioned without departing from the disclosure.

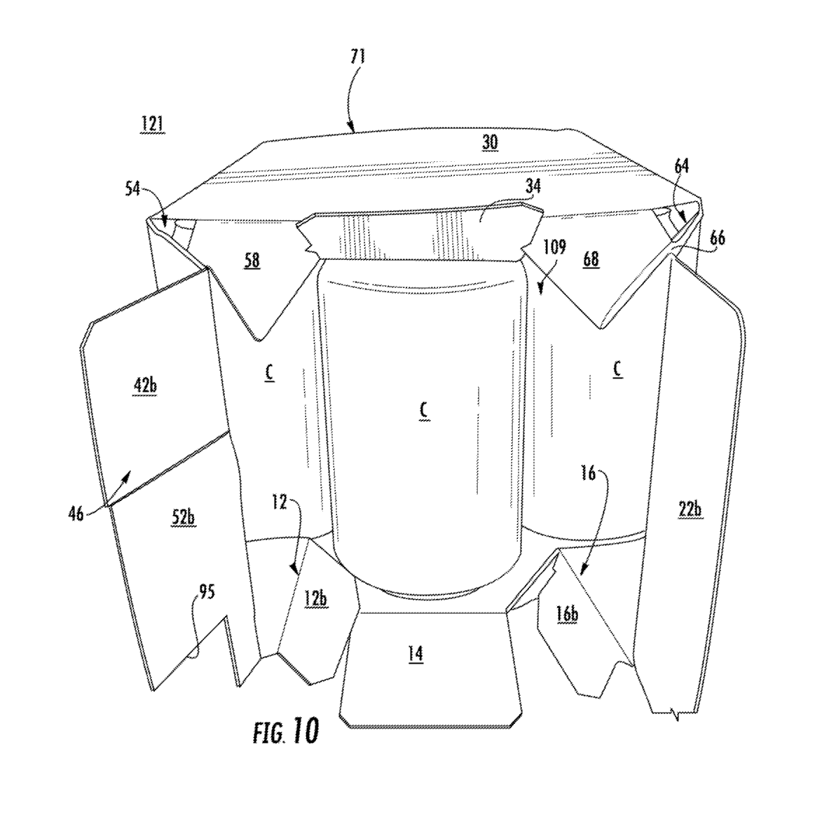

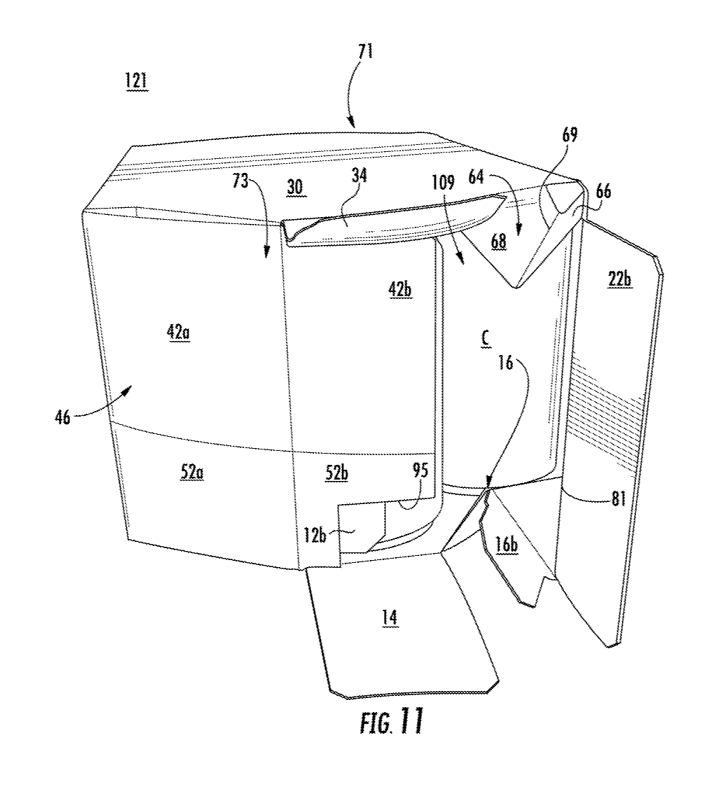

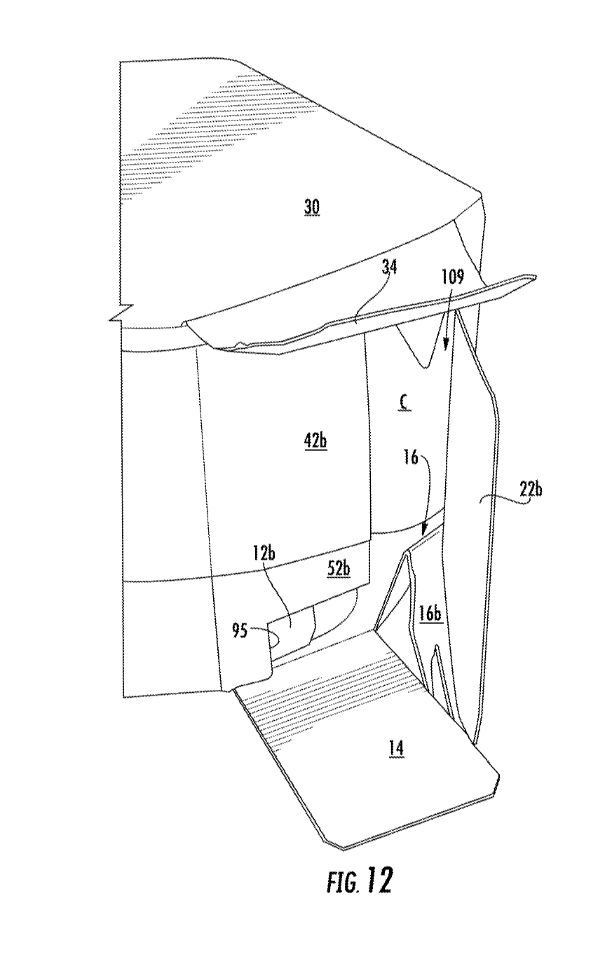

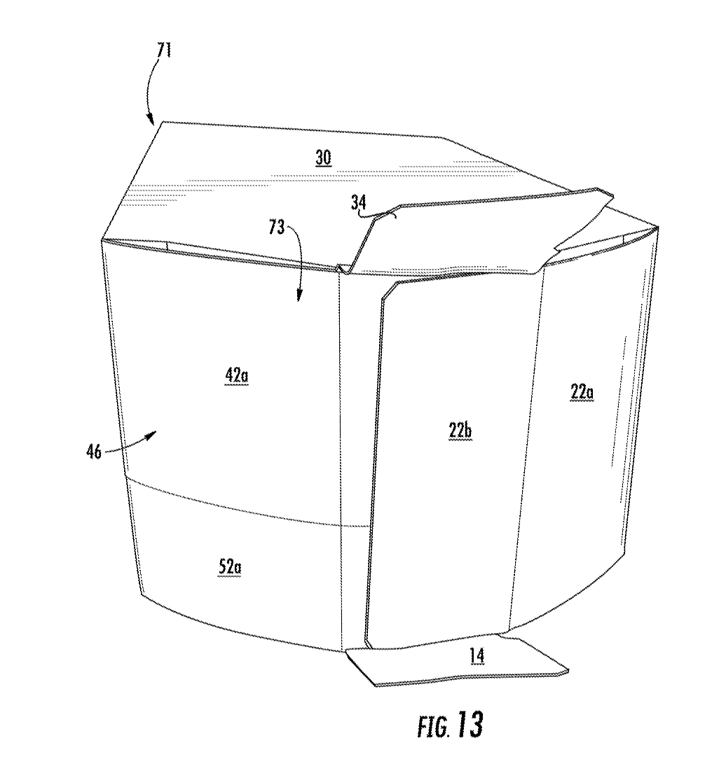

In the illustrated embodiment, the blank 3 is generally a mirror-image about its longitudinal centerline CL such that the end flaps 12, 14, 16, 22, 34, 42, 52 and the gussets 54 that extend along one marginal area of the blank 3 have similar or identical features at the second marginal area of the blank 3 that are mirror images of the features at the first marginal area of the blank 3, with the exceptions that the end flap 22 at the second marginal area of the blank 3 is devoid of notches 91, 93 and an additional gusset 64 is provided at the second marginal area of the blank 3 between the top panel 30 and the end flap 22 instead of an end flap 32. The gusset 64, as shown, has a similar configuration to gusset 54 and includes a first gusset panel 66 and a second gusset panel 68. The second gusset panel 68 is foldably connected to the top panel 30 at an oblique fold line 67, is foldably connected to the first gusset panel 66 at an oblique fold line 69, and the first gusset panel 66 is foldably connected to the first side panel 20 along a portion of the fold line 31. The end flaps 12, 14, 16, 22, 32, 34, 42, 52 and the gusset 54 at the first marginal area of the blank 3 are configured to close a first end 71 of the carton 5 (FIG. 14) and the end flaps 12, 14, 16, 22, 32, 42, 52 and gussets 54, 64 at the second marginal area of the blank 3 are configured to close a second end 73 of the carton 5 (FIGS. 10-13). One or both of the ends 71, 73 of the carton 5 could be could be otherwise shaped, arranged, configured, and/or positioned without departing from the disclosure.

In the illustrated embodiment, the bottom end flaps 12, 16 each have a gusset portion 12a, 16a or base portion with respective oblique fold line 75, 77 extending at least partially across the respective gusset portions 12a, 16a and respective distal portions 12b, 16b foldably connected to the gusset portions 12a, 16a at portions of respective longitudinal fold lines 79, 81. Each of the gusset portions 12a, 16a comprises a respective two gusset panels 12c, 12d and 16c, 16d foldably connected at the respective fold lines 75, 77. The side end flap 52, as shown has a base portion 52a foldably connected to the side panel 50 at the fold line 53 and a distal portion 52b foldably connected to the base portion 52a at a portion of the fold line 79. The base portion 52a of the side end flap 52, as shown, is foldably connected to the gusset panel 12c at a portion of the lateral fold line 51. Similarly, the side end flap 22 comprises a base portion 22a foldably connected to the side panel 20 at the longitudinal fold line 25 and a distal portion 22b, which includes the notches 91, 93, foldably connected to the base portion 22a at a portion of the fold line 81. The top end flap 32 is similar to the bottom end flaps 12, 16 in that the top end flap 32 has a gusset portion 32a comprising two gusset panels 32c, 32d foldably connected at an oblique fold line 83, and a distal portion 32b foldably connected to the gusset panel 32c at a portion of the fold line 81. The side end flap 42, as shown, comprises a base portion 42a foldably connected to the side panel 40 at the fold line 43 and foldably connected to the gusset panel 56 at a portion of the fold line 41, and a distal portion 42b foldably connected to the base portion 42a at a longitudinal fold line 85. Any of the end flaps 12, 14, 16, 22, 32, 34 42, 52 could be omitted or could be otherwise shaped, arranged, configured, and/or positioned without departing from the disclosure.

In the illustrated embodiment, the side end flap 22 has the respective corner notches 91, 93 in the distal portion 22b of the side end flap 22. Similarly, the side end flap 52 has a corner notch 95 in the distal portion 52b of the side end flap 52. As shown in FIG. 1, the blank 3 includes handle features for forming a handle 105 in the carton 5 (FIG. 14). As shown in FIG. 1, the handle features include respective handle openings 97, 99 in a respective second side panel 40 and third side panel 50. In one embodiment, the blank 3 includes dispenser features for forming a dispenser 107 in the carton 5 (FIG. 17). The dispenser features include a dispenser panel 102 defined by a dispenser tear line 104. In the illustrated embodiment, the dispenser panel 102 comprises portions of the bottom panel 10, the first side panel 20, the top panel 30, and the gusset panels 16c, 16d, 32c, 32d. In one embodiment, the dispenser panel 102 includes access features 106 in each of the bottom panel 10 and top panel 30 for grasping the dispenser panel 102 and tearing along dispenser tear line 104. The blank 3 could have other features or the features shown could be otherwise shaped, arranged, and/or configured without departing from the disclosure.

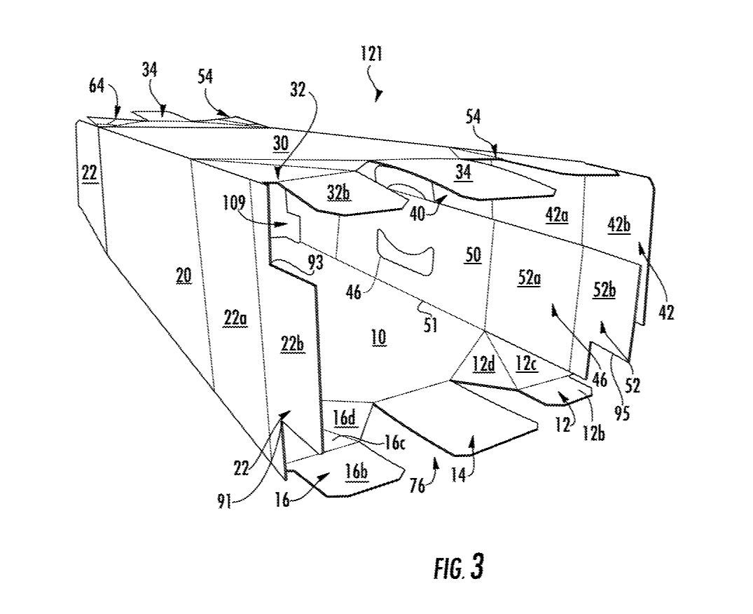

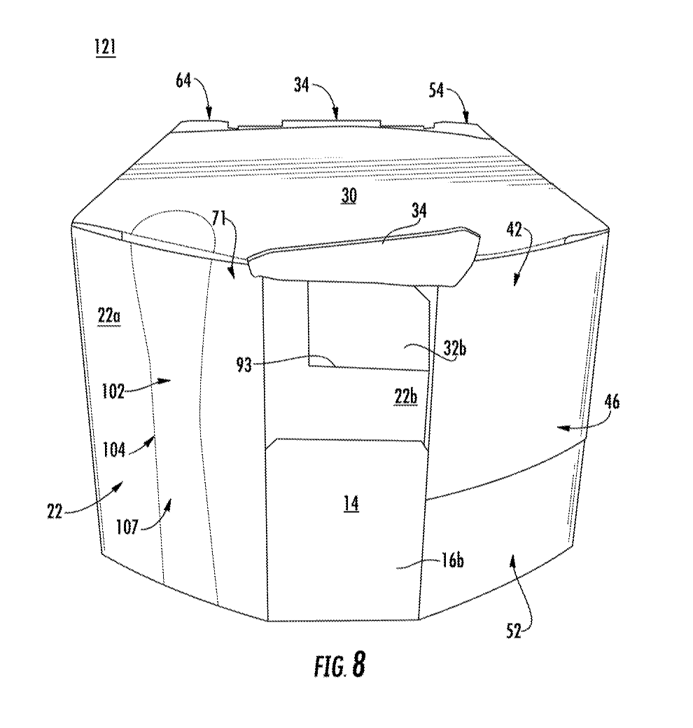

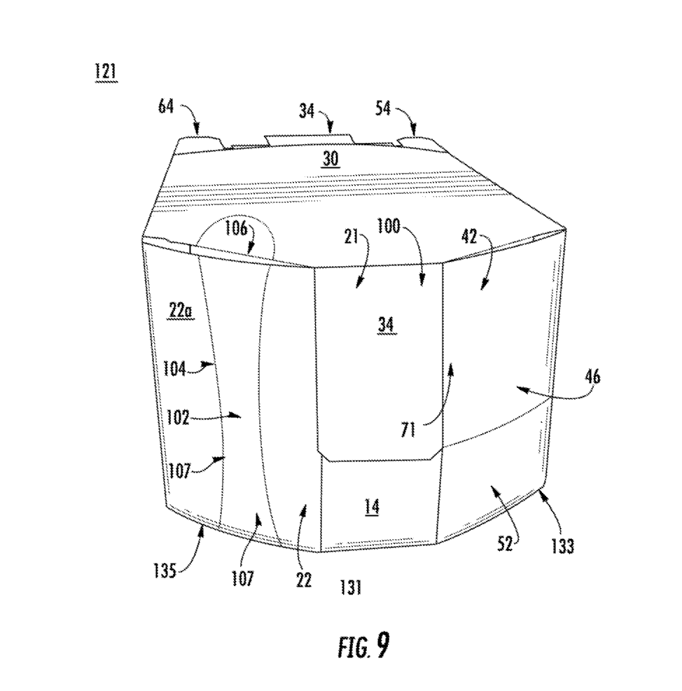

With continued reference to FIG. 1, and referring additionally to FIGS. 3-14, various features and steps of one exemplary method of forming the carton 5 from the blank 3 are shown. As shown in FIG. 3, the blank 3 is folded about the fold lines 51, 21, 31, and 41 so that the second side panel 40 at least partially overlaps and is adhered to the third side panel 50 to form a side panel 46, and the side panel 46 and the first side panel 20 are positioned relative to the bottom panel 10 and the top panel 30 to form an open-ended sleeve 121 with an interior 109. The interior 109 of the open-ended sleeve 121 form the interior 109 of the carton 5. In one embodiment, the cans C are grouped together and loaded into the open-ended sleeve 121 in the nested configuration N13 shown in FIG. 2. One of the ends 71, 73 can be closed prior to loading the cans C or the ends 71, 73 can remain open during loading of the cans C without departing from the disclosure. Further, the cans C could be arranged in a different nesting configuration without departing from the disclosure.

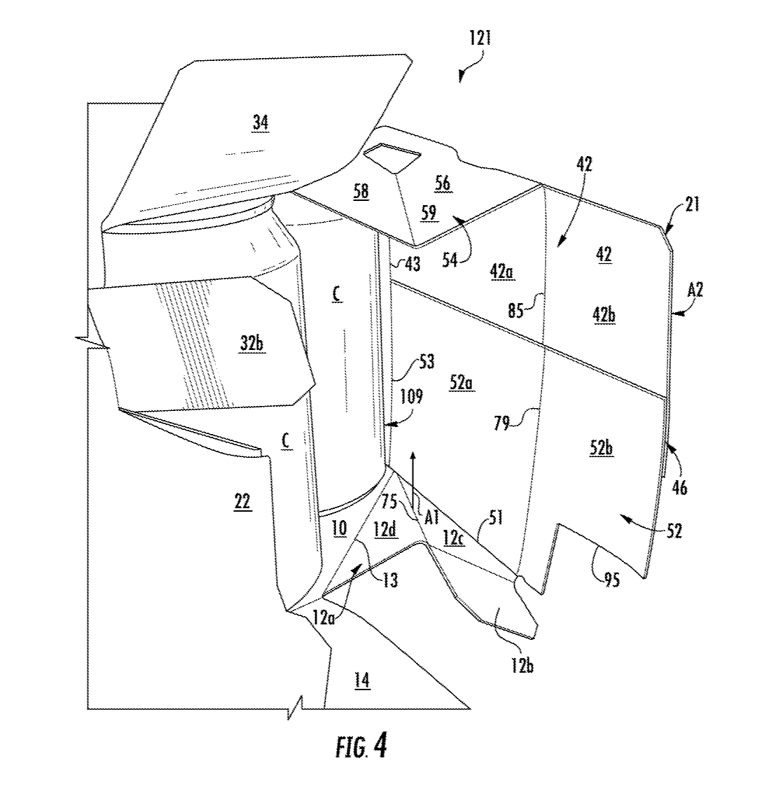

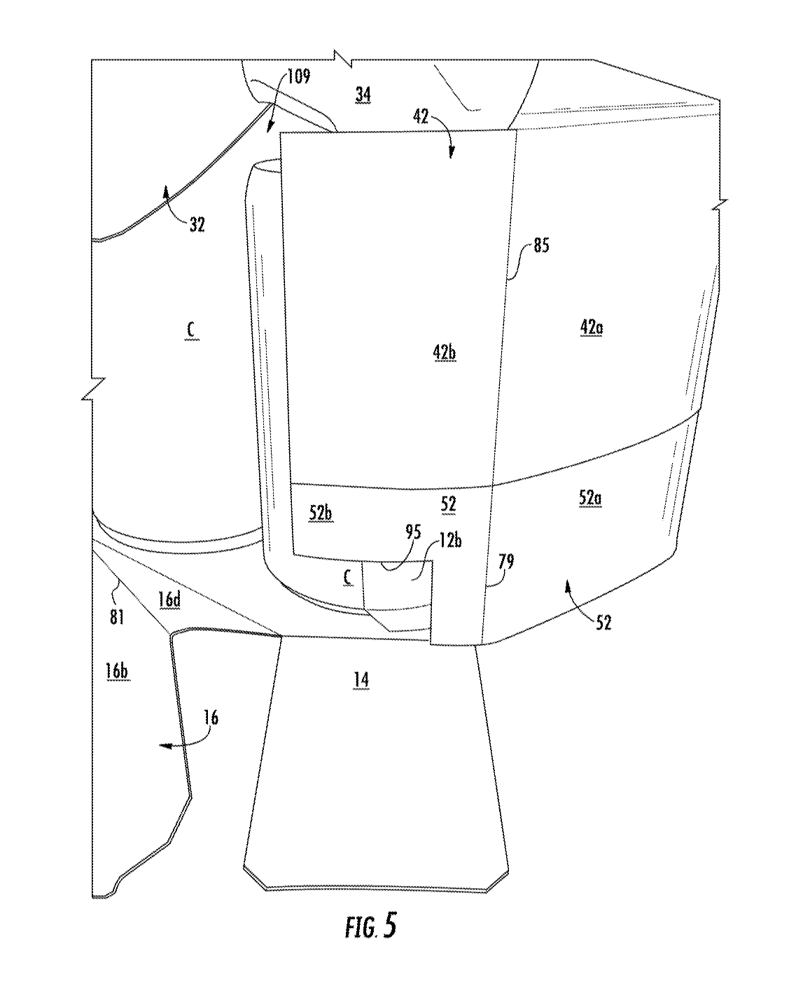

Still referring to FIG. 1, and as shown in FIGS. 4-9, the closing of the end 71 of the carton 5 (FIG. 14) will be described, but the closing of the other end 73 can be identical to the end 71 described herein. Alternatively, the end 73 can have other features and/or could have other closing steps without departing from the disclosure. As shown in FIG. 4, the bottom end flap 12 can be upwardly folded about fold line 13 and the gusset portions 12c, 12d are folded inwardly at the fold line 75 in the direction of arrow A1, e.g., in a peaked condition, so that the gusset portions 12c, 12d overlap and the distal portion 12b is correspondingly rotated toward the side panel 46. Next, the side panel 46 that includes overlapped side end flaps 42, 52 is folded inward in the direction of A2 (FIG. 4) about fold lines 43, 53 to the position of FIG. 5. The distal portions 42b and 52b may also be at least partially folded about respective fold lines 85, 79 in such a position. As shown in FIG. 5, the distal portion 12b of the bottom end flap 12 is positioned to be overlapped by the notch 95 of the side end flap 52 such that a portion of the distal portion 12b of the bottom end flap 12 is exposed adjacent the side end flap 52. Also shown in FIG. 5, the base portions 42a, 52a of the side end flaps 42, 52 are positioned to be oblique relative to the remainder of the side panel 46 upon the folding described herein. As shown, the gusset 54 is activated when the side end flaps 42, 52 are folded inward to partially close the end 71 so that the gusset panels 56, 58 are folded about fold line 59 such that the gusset panels 56, 58 are in face-to-face contact and overlap with the side end flap 42 overlapping the gusset panel 56. In embodiments, the gusset 54 may be directly activated by a user.

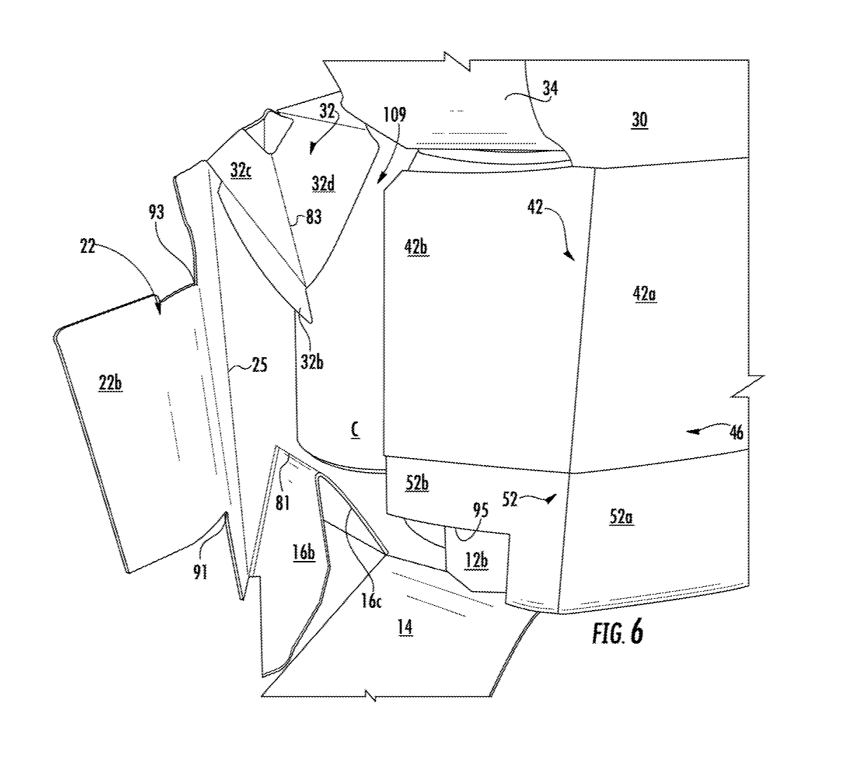

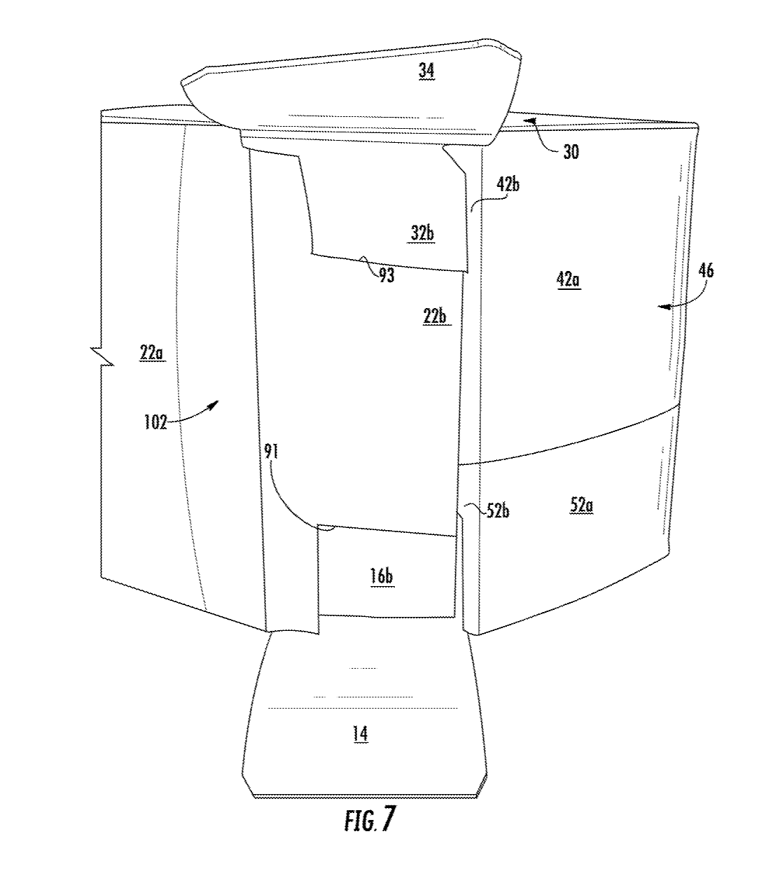

As shown in FIGS. 5 and 6, the bottom end flap 16 is folded in a similar manner as the bottom end flap 12. In particular, the two gusset portions 16c, 16d are folded relative to each other about the fold line 77 and into face-to-face contact and the distal portion 16b is correspondingly toward the side panel 20 as the end flap 16 is closed. The top end flap 32 can be similarly closed, as shown, by folding the gusset portions 32c, 32d relative to each other about fold line 83 and into face-to-face contact with the distal portion 32b correspondingly rotated toward the side panel 20. As shown, the side end flap 22 is closed by folding along the fold line 25 and a portion of the fold line 81. As the side end flap 22 is closed over the side panel 46 in partial overlapping relation, the distal portion 16b of the bottom end flap 16 and the distal portion 32b of the top end flap 32 are positioned so that the respective notches 91, 93 overlap portions of the respective distal portions 16b, 32b, with portions of the distal portion 16b, 32b exposed adjacent the side end flap 22, as shown. The distal portion 22b of the side end flap 22 is thus folded to overlap a portion of the distal portions 42b, 52b of the overlapped side end flaps 42, 52 and can be adhered to the distal portions 42b, 52b in such position. Also as shown, as the end flap 22 is folded, the distal portions 16b, 32b of the respective end flaps 16, 32 are urged against portions of the flaps 42, 52, 12, with portions of the distal portions 16b, 32b exposed adjacent the respective cutouts 91, 93. With continued reference to FIG. 1, and as shown in FIGS. 7-9, the bottom end flap 14 is upwardly folded to at least partially overlap the overlapped distal portions 12b, 16b, 22b, 42b, 52b of the respective end flaps 12, 16, 22, 42, 52. Similarly, the top end flap 34 is folded to at least partially overlap the overlapped distal portions 32b, 22b, 42b, of the respective end flaps 32, 22, 42 as well as the bottom end flap 14. In embodiments, the top end flap 34 and/or the bottom end flap 14 can overlap portions of one or more of the gusset panels 32c, 32d, 16c, 16d, 12c, 12d, 56, and 58. The overlapping portions of flaps 12, 16, 22, 42, 52, 14, 34 can be secured to one another with an adhesive such as glue. In this regard, the exposed portions of the end flaps 32b, 16b adjacent the respective notches 91, 93 of the end flap 22 are available as adhesion surfaces to respective overlapping end flaps 34, 14, and the exposed portion of the end flap 12 adjacent the cutout 95 are available as adhesion surfaces to respective overlapping end flap 32 to provide a secure closure 100 at the end 71 of the carton 5 (FIG. 14). The end 71 of the carton 5 can be closed by other steps than shown and described herein without departing from the disclosure.

Still referring to FIG. 1, and as shown in FIGS. 10-13, the second end 73 of the carton 5 can be closed in a similar manner as described above for the first end 71 of the carton 5. In particular, the gussets 54, 64 and end flaps 12, 16 can be activated, e.g., folded inwardly about respective fold lines 59, 69 and 75, 77 such that the respective gusset panels 56 and 58, 66 and 68, 12c and 12d, and 16c and 16d are in face-to-face contact, with the distal portion 12b of the end flap 12 rotated toward the side panel 46 and the distal portion 16b of the end flap 16 rotated toward the side panel 20. As shown, the overlapped side panels 42, 52 can be folded about respective fold lines 43, 53 such that the cutout 95 of the distal portion 52b of the side panel 52 overlaps a portion of the distal portion 12b of the end flap 12. In this regard, a portion of the distal portion 12b of the end flap 12 is exposed adjacent the side panel 52. The top panel 22, as shown, can also be folded at fold line 81 such that a portion of the top panel 22 overlaps portions of the side panels 42, 52. The bottom end flap 14 can then be folded upwardly to at least partially overlap the overlapped distal portions 12b, 16b, 22b, 42b, 52b of the respective end flaps 12, 16, 22, 42, 52. Similarly, the top end flap 34 is folded to at least partially overlap the overlapped distal portions 22b, 42b, of the respective end flaps 32, 22, 42 as well as the bottom end flap 14. In embodiments, the top end flap 34 and/or the bottom end flap 14 can overlap portions of one or more of the gusset panels 32c, 32d, 16c, 16d, 12c, 12d, 56, 58, 66, and 68. The overlapping portions of flaps 12, 16, 22, 42, 52, 14, and 34 can be secured to one another with an adhesive such as glue. The end 73 of the carton 5 can be closed by other steps than shown and described herein or can have a different configuration than described herein without departing from the disclosure. For example, in embodiments, the end 73 of the carton 5 can have a similar configuration to the end 71 of the carton 5 described above.

As shown in FIG. 14 each of the ends 71, 73 of the carton 5 have a central portion 131 that is generally perpendicular to the side panels 20, 46, and is generally aligned with the fold lines 15, 35. The ends 71, 73 have two oblique side portions 133, 135 on a respective side of the central portion 131 that are respectively aligned with the fold lines 13, 17. In the illustrated embodiment, the configuration of the ends 71, 73 with central portion 131 and oblique side portions 133, 135 facilitates receiving the nested arrangement N13 (FIG. 2) of cans C. Such a configuration of the carton 5 may conserve material, for example, as compared to a conventional carton that lacks oblique side portions. Further, the configuration of the carton 5 may be readily distinguishable from other conventional cartons. Either or both of the ends 71, 73 of the carton 5 could be otherwise shaped, arranged, positioned, and/or configured without departing from the disclosure, and the nested arrangement N13 could be an alternative nested arrangement (e.g., nested arrangement N1-N12, or a nested arrangement that is otherwise configured) without departing from the disclosure.

As also shown in FIG. 14, the carton 5 can be carried by the handle 105 by rotating the loaded and closed carton 5 so that the side panel 20 is facing downward and the side panel 46 formed by the overlapped side panels 40, 50 in the upright position shown. The handle openings 97, 99 can be accessed by a user and a handle portion 98 between the handle openings 97, 99 formed by portion of the side panel 40 and/or the side panel 50 can be grasped to lift and carry the carton 5. The handle 105 could be otherwise shaped, arranged, configured, and/or omitted without departing from the disclosure.

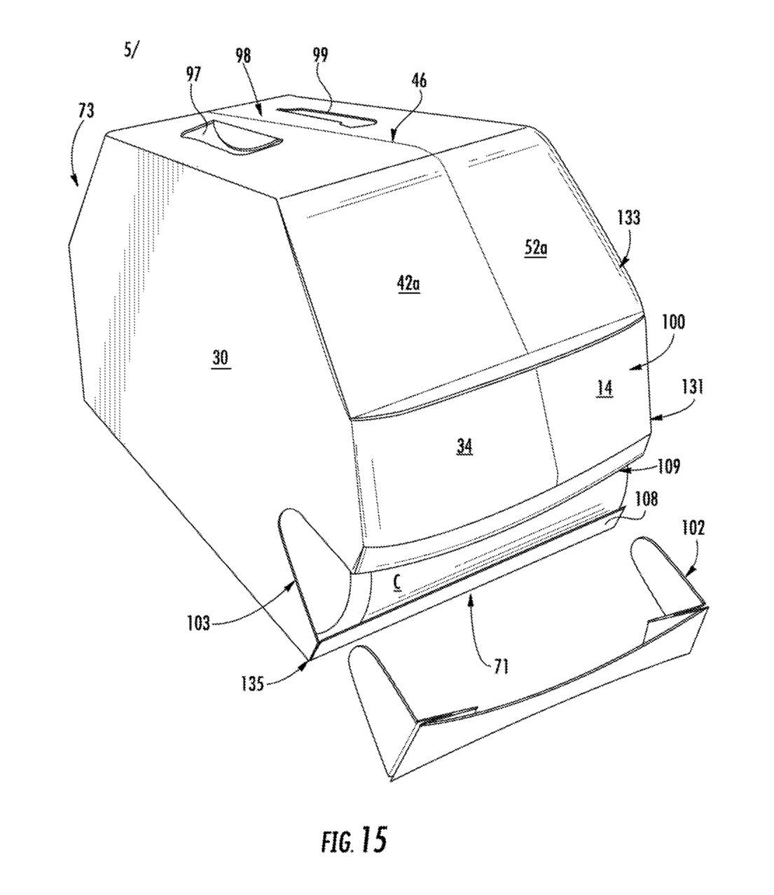

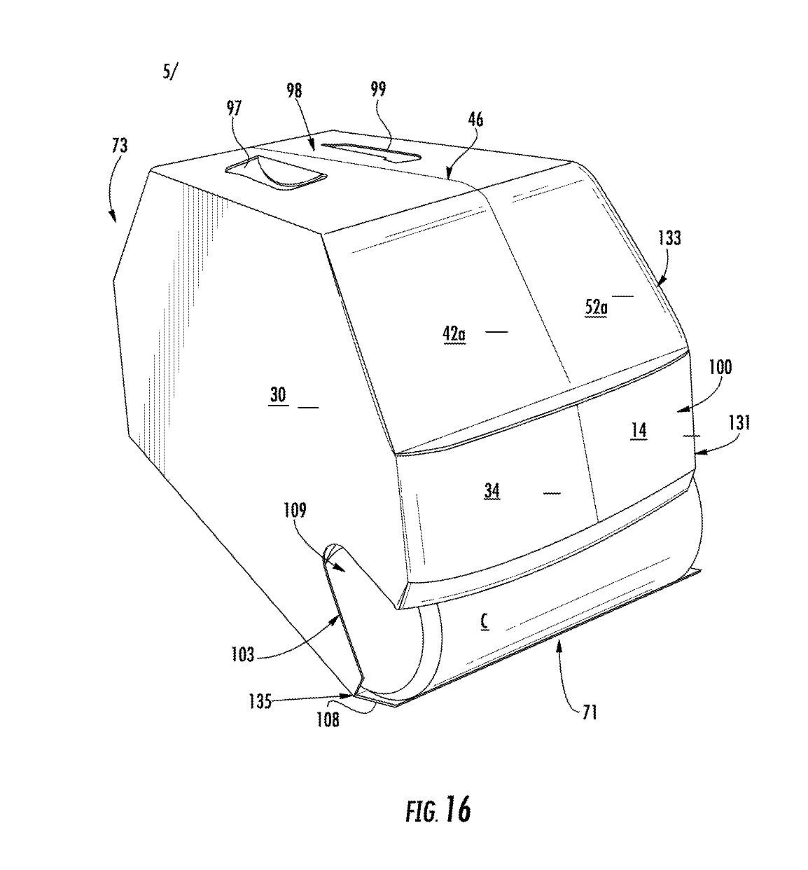

As shown in FIGS. 15 and 16, the cans C in the assembled, loaded, and closed carton 5 can be accessed activating the dispenser 107 on the closed end 71 of the carton 5. The dispenser 107 is activated by removing the dispenser panel 102 by tearing along the tear line 104 to create a dispenser opening 103 for removal of the cans C. As shown, the arrangement of the secure closure 100 remains intact above the dispenser opening 103 to retain cans C within the carton 5. As also shown, the portion of the side panel 20 below the dispenser opening 103 provides a lip 108 that partially engages a container C for removal from the carton 5. As shown, the container C that partially rests upon the lip 108 can be grasped by top and bottom portions of the container C (which is disposed on its side) along lateral portions of the dispenser opening 103 provided by the removal of access features 106. Upon removal of the container C from the lip 108, a sequentially next container C from the interior of the carton 5 can roll or fall into position in the lip 108 for access by a user. As shown, the lip 108 may cant or tilt slightly outward from the carton 5 under the weight of a container C. The dispenser 107 can be otherwise shaped, arranged, configured, and/or omitted without departing from the disclosure.

Any of the features of the various embodiments of the disclosure can be combined with, replaced by, or otherwise configured with other features of other embodiments of the disclosure without departing from the scope of this disclosure. Further, it is noted that the nesting arrangements and/or the features of the blanks and cartons of the various embodiments can be incorporated into a carton or blank having any carton style or panel configuration. The carton styles and panel configurations described above are included by way of example.

The blanks according to any of the embodiments of the present disclosure can be, for example, formed from coated paperboard and similar materials. For example, the interior and/or exterior sides of the blank can be coated with a clay coating. The clay coating may then be printed over with product, advertising, price coding, and other information or images. The blank may then be coated with a varnish to protect any information printed on the blank. The blank may also be coated with, for example, a moisture barrier layer, on either or both sides of the blank. In accordance with the above-described embodiments, the blank may be constructed of paperboard of a caliper such that it is heavier and more rigid than ordinary paper. The blank can also be constructed of other materials, such as cardboard, hard paper, or any other material having properties suitable for enabling the carton to function at least generally as described herein. The blank can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for containing a plurality of containers, comprising:
a plurality of panels that extends at least partially around an interior of the carton, the plurality of panels comprising a bottom panel, a top panel, and at least one side panel; and
a plurality of end flaps foldably connected to respective panels of the plurality of panels and at least partially closing an end of the carton, the plurality of end flaps comprising a first end flap foldably connected to one of the top panel and the bottom panel at a first fold line, a second end flap foldably connected to the one of the top panel and the bottom panel at a second fold line that is oblique to the first fold line, and a third end flap foldably connected to the at least one side panel at a third fold line, the third end flap has at least one notch overlapping at least a portion of one of the first end flap and the second end flap.

2. The carton of claim 1, wherein the third end flap is at least partially disposed between the first end flap and the second end flap.

3. The carton of claim 2, wherein the first end flap is in face-to-face contact with the second end flap through the notch.

4. The carton of claim 2, wherein the first end flap is adhered to the second end flap.

5. The carton of claim 4, wherein the plurality of end flaps further comprises a fourth end flap foldably connected to an other of the top panel and the bottom panel at a fourth fold line and a fifth end flap foldably connected to the other of the top panel and the bottom panel at a fifth fold line that is oblique to the fourth fold line, and the at least one notch comprises a first notch overlapping the at least a portion of one of the first end flap and the second end flap and a second notch overlapping at least a portion of one of the fourth end flap and the fifth end flap.

6. The carton of claim 5, wherein the third end flap is at least partially disposed between the fourth end flap and the fifth end flap.

7. The carton of claim 6, wherein the fourth end flap is in face-to-face contact with the fifth end flap through the second notch.

8. The carton of claim 6, wherein the fourth end flap is adhered to the fifth end flap.

9. The carton of claim 8, wherein the first end flap is adhered to the fourth end flap.

10. The carton of claim 1, wherein at least one end flap of the plurality of end flaps comprises a plurality of gusset panels.

11. The carton of claim 1, wherein the plurality of end flaps form a central portion of the closed end that is generally perpendicular to the at least one side panel.

12. The carton of claim 11, wherein the plurality of end flaps form an oblique side portion of the closed end extending between the central portion and the at least one side panel.

13. The carton of claim 1, wherein the carton comprises a removable dispenser panel for forming a dispenser opening.

14. The carton of claim 13, wherein the dispenser panel comprises at least a portion of the bottom panel, the top panel, the at least one side panel, and at least one end flap of the plurality of end flaps.

15. The carton of claim 14, wherein the dispenser panel comprises access features comprising at least a portion of the bottom panel and the top panel.

16. The carton of claim 15, wherein, upon removal of the dispenser panel, a portion of the bottom panel forms a retention feature to retain at least one container of the plurality of containers in the interior of the carton.

17. The carton of claim 13, wherein overlapping portions of the first end flap, the second end flap, and the third end flap form a secure closure of the carton, and, upon removal of the dispenser panel, the secure closure remains intact.

18. A blank for forming a carton for containing a plurality of containers, comprising:
a plurality of panels for folding at least partially around an interior of the carton, the plurality of panels comprising a bottom panel, a top panel, and at least one side panel; and
a plurality of end flaps foldably connected to respective panels of the plurality of panels and for at least partially closing an end of the carton when the carton is formed from the blank, the plurality of end flaps comprising a first end flap foldably connected to one of the top panel and the bottom panel at a first fold line, a second end flap foldably connected to the one of the top panel and the bottom panel at a second fold line that is oblique to the first fold line, and a third end flap foldably connected to the at least one side panel at a third fold line and having at least one notch for overlapping at least a portion of one of the first end flap and the second end flap when the carton is formed from the blank.

19. The blank of claim 18, wherein the third end flap is at least partially disposed between the first end flap and the second end flap when the carton is formed from the blank.

20. The blank of claim 19, wherein the first end flap is in face-to-face contact with the second end flap through the notch when the carton is formed from the blank.

21. The blank of claim 19, wherein the first end flap is adhered to the second end flap when the carton is formed from the blank.

22. The blank of claim 21, wherein the plurality of end flaps further comprises a fourth end flap foldably connected to an other of the top panel and the bottom panel at a fourth fold line and a fifth end flap foldably connected to the other of the top panel and the bottom panel at a fifth fold line that is oblique to the fourth fold line, and the at least one notch comprises a first notch overlapping the at least a portion of one of the first end flap and the second end flap and a second notch overlapping at least a portion of one of the fourth end flap and the fifth end flap when the carton is formed from the blank.

23. The blank of claim 22, wherein the third end flap is at least partially disposed between the fourth end flap and the fifth end flap when the carton is formed from the blank.

24. The blank of claim 23, wherein the fourth end flap is in face-to-face contact with the fifth end flap through the second notch when the carton is formed from the blank.

25. The blank of claim 23, wherein the fourth end flap is adhered to the fifth end flap when the carton is formed from the blank.

26. The blank of claim 25, wherein the first end flap is adhered to the fourth end flap when the carton is formed from the blank.

27. The blank of claim 18, wherein at least one end flap of the plurality of end flaps comprises a plurality of gusset panels.

28. The blank of claim 18, wherein the plurality of end flaps form a central portion of the closed end that is generally perpendicular to the at least one side panel when the carton is formed from the blank.

29. The blank of claim 28, wherein the plurality of end flaps form an oblique side portion of the closed end extending between the central portion and the at least one side panel when the carton is formed from the blank.

30. The blank of claim 18, wherein the blank comprises a removable dispenser panel for forming a dispenser opening when the carton is formed from the blank.

31. The blank of claim 30, wherein the dispenser panel comprises at least a portion of the bottom panel, the top panel, the at least one side panel, and at least one end flap of the plurality of end flaps.

32. The blank of claim 31, wherein the dispenser panel comprises access features comprising at least a portion of the bottom panel and the top panel.

33. The blank of claim 32, wherein, upon removal of the dispenser panel, a portion of the bottom panel forms a retention feature to retain at least one container of the plurality of containers in the interior of the carton when the carton is formed from the blank.

34. The blank of claim 30, wherein overlapping portions of the first end flap, the second end flap, and the third end flap form a secure closure of the carton when the carton is formed from the blank, and, upon removal of the dispenser panel, the secure closure remains intact.

35. A method of forming a carton for containing a plurality of containers, comprising:
obtaining a blank comprising a plurality of panels that comprises a bottom panel, a top panel, and at least one side panel, the blank comprising a plurality of end flaps foldably connected to respective panels of the plurality of panels and comprising a first end flap foldably connected to one of the top panel and the bottom panel at a first fold line, a second end flap foldably connected to the one of the top panel and the bottom panel at a second fold line that is oblique to the first fold line, and a third end flap foldably connected to the at least one side panel at a third fold line and having at least one notch; and
folding the plurality of panels and the plurality of end flaps to extend at least partially around an interior of the carton such that the at least one notch overlaps at least a portion of one of the first end flap and the second end flap.

36. The method of claim 35, wherein the third end flap is at least partially disposed between the first end flap and the second end flap when the plurality of panels and the plurality of end flaps are folded.

37. The method of claim 36, wherein the first end flap is in face-to-face contact with the second end flap through the notch when the plurality of panels and the plurality of end flaps are folded.

38. The method of claim 36, wherein the first end flap is adhered to the second end flap when the plurality of panels and the plurality of end flaps are folded.

39. The method of claim 38, wherein the plurality of end flaps further comprises a fourth end flap foldably connected to an other of the top panel and the bottom panel at a fourth fold line and a fifth end flap foldably connected to the other of the top panel and the bottom panel at a fifth fold line that is oblique to the fourth fold line, and the at least one notch comprises a first notch overlapping the at least a portion of one of the first end flap and the second end flap and a second notch overlapping at least a portion of one of the fourth end flap and the fifth end flap when the plurality of panels and the plurality of end flaps are folded.

40. The method of claim 39, wherein the third end flap is at least partially disposed between the fourth end flap and the fifth end flap when the plurality of panels and the plurality of end flaps are folded.

41. The method of claim 40, wherein the fourth end flap is in face-to-face contact with the fifth end flap through the second notch when the plurality of panels and the plurality of end flaps are folded.

42. The method of claim 40, wherein the fourth end flap is adhered to the fifth end flap when the plurality of panels and the plurality of end flaps are folded.

43. The method of claim 42, wherein the first end flap is adhered to the fourth end flap when the plurality of panels and the plurality of end flaps are folded.

44. The method of claim 35, wherein at least one end flap of the plurality of end flaps comprises a plurality of gusset panels.

45. The method of claim 35, wherein the plurality of end flaps form a central portion of the closed end that is generally perpendicular to the at least one side panel when the plurality of panels and the plurality of end flaps are folded.

46. The method of claim 45, wherein the plurality of end flaps form an oblique side portion of the closed end extending between the central portion and the at least one side panel when the plurality of panels and the plurality of end flaps are folded.

47. The method of claim 35, wherein the blank comprises a removable dispenser panel for forming a dispenser opening when the plurality of panels and the plurality of end flaps are folded.

48. The method of claim 47, wherein the dispenser panel comprises at least a portion of the bottom panel, the top panel, the at least one side panel, and at least one end flap of the plurality of end flaps.

49. The method of claim 48, wherein the dispenser panel comprises access features comprising at least a portion of the bottom panel and the top panel.

50. The method of claim 49, wherein, upon removal of the dispenser panel, a portion of the bottom panel forms a retention feature to retain at least one container of the plurality of containers in the interior of the carton when the plurality of panels and the plurality of end flaps are folded.

51. The method of claim 50, wherein overlapping portions of the first end flap, the second end flap, and the third end flap form a secure closure of the carton when the plurality of panels and the plurality of end flaps are folded, and, upon removal of the dispenser panel, the secure closure remains intact.
